(19) United States
(12) Patent Application Publication
(10) Pub. No.: US 2026/0081477 A1
(43) Pub. Date: Mar. 19, 2026

(54) SYSTEM FOR INDUCTIVELY TRANSFERRING POWER FROM A PRIMARY DEVICE TO A SECONDARY DEVICE, PRIMARY DEVICE, AND METHOD FOR OPERATING SUCH A SYSTEM

(71) Applicant: Turck Holding GmbH, Halver (DE)

(72) Inventor: Tobias Gerz, Schwarzenberg (DE)

(73) Assignee: Turck Holding GmbH, Halver (DE)

(21) Appl. No.: 19/362,569

(22) Filed: Oct. 20, 2025

Related U.S. Application Data
(63) Continuation of application No. PCT/EP2024/060875, filed on Apr. 22, 2024.

(30) Foreign Application Priority Data
Apr. 25, 2023 (DE) 10 2023 110 454.3

(51) Int. Cl. H02J 50/60; H02J 50/12; H02J 50/80; H02J 50/90

(52) U.S. Cl. CPC H02J 50/60; H02J 50/12; H02J 50/80; H02J 50/90

(57) ABSTRACT

An inductive power transfer system is provided, comprising a primary device, a secondary device, and a control unit, wherein the primary device is arranged and designed to inductively transfer power via a primary oscillating circuit to a secondary oscillating circuit of the secondary device during the transfer of power, wherein the control unit is designed to record secondary power data of the secondary device and to determine primary target power data using a power characteristic and the recorded secondary power data, wherein the power characteristic comprises reference primary power data as a function of reference secondary power data, wherein the control unit is designed to record primary power data of the primary device and to detect a foreign object using a comparison of the primary target power data with the primary power data.

### CROSS REFERENCE TO RELATED APPLICATIONS

This application is a continuation application of international patent application PCT/EP2024/060875, filed on Apr. 22, 2024, and designating the U.S., which claims priority to German patent application 10 2023 110 454.3, filed on Apr. 25, 2023, each of which are hereby incorporated by reference in their entireties.

### TECHNICAL FIELD

The present disclosure relates to a system for the inductive transfer of power from a primary device to a secondary device, to a primary device and to a method for operating a system for the inductive transfer of power. The disclosure is therefore in the technical field of contactless transfer of power (also referred to as Wireless Power Transfer) and inductive couplers.

### BACKGROUND

Power can be transferred inductively between a primary device (transmitter) and a secondary device (receiver) via an electromagnetic field.

One possible challenge when using such inductive couplers is that of identifying metallic foreign objects in the electromagnetic field between the transmitter and the receiver during the contactless transfer of power. Depending on the method used, foreign object detection (FOD) can be dependent on the distance between transmitter and receiver and on the power that is to be transferred to the secondary device. The properties of the foreign object can also have an effect on its detectability.

Some inductive coupler systems interrupt the transfer of power if a fixed limit value for the primary-side input power is exceeded during the transfer of power between primary device and secondary device.

CN 114709943 A proposes an apparatus for the cable-free charging of a device, wherein a foreign object and an offset in the vertical or horizontal direction are recorded using the input voltage, the input current and the peak values of the voltage at the coil. This is based on the prerequisites of the Qi standard, which requires physical contact between the device and the charging station, for example.

An apparatus for detecting foreign objects in a wireless current-transfer system is known from EP 2 768 112 B1, wherein a foreign object is detected using an error message and request to increase the energy.

U.S. Pat. No. 10,658,878 B2 describes an apparatus for cable-free charging, which comprises temperature sensors.

### SUMMARY

An inductive power transfer system is provided, comprising a primary device, a secondary device, and a control unit, wherein the primary device is arranged and designed to inductively transfer power via a primary oscillating circuit to a secondary oscillating circuit of the secondary device during the transfer of power, wherein the control unit is designed to record secondary power data of the secondary device and to determine primary target power data using a power characteristic and the recorded secondary power data, wherein the power characteristic comprises reference primary power data as a function of reference secondary power data, wherein the control unit is designed to record primary power data of the primary device and to detect a foreign object using a comparison of the primary target power data with the primary power data.

A primary device for an inductive transfer of power from the primary device to a secondary device is provided, comprising a control unit and a primary device interface, wherein the control unit is designed to record, via the primary device interface, secondary power data of a secondary device coupled to the primary device for the inductive transfer of power and to determine primary target power data using the recorded secondary power data and a power characteristic, wherein the power characteristic includes reference primary power data as a function of reference secondary power data, and wherein the control unit is designed to record primary power data of the primary device and to detect a foreign object using a comparison of the primary target power data with the primary power data.

A method for operating a system for an inductive transfer of power from a primary device to a secondary device is provided, comprising recording primary power data of the primary device and secondary power data of the secondary device during the inductive transfer of power, determining primary target power data using a power characteristic and the recorded secondary power data, and detecting a foreign object using a comparison of the primary target power data with the primary power data.

### BRIEF DESCRIPTION OF THE DRAWINGS

In the drawings:

FIG. 1 shows a schematic depiction of an exemplary implementation of a system for the inductive transfer of power;

FIG. 2 shows an exemplary implementation of the method for operating a system for the inductive transfer of power;

FIG. 3 shows an example of recorded data of a power reference measurement at various distances;

FIG. 4 shows an example of a power characteristic determined using the recorded data;

FIG. 5 shows a schematic depiction of an exemplary implementation of a functional principle for the inductive transfer of power;

FIG. 6 shows an example of recorded data of a distance reference measurement;

FIG. 7 shows an example of power characteristics determined using the recorded data; and

FIG. 8 shows an example of fitted characteristics of a distance characteristic field.

### DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

One possible object of the present disclosure can be to provide a system for the inductive transfer of power, a primary device and a method for operating such a system, wherein a high level of operational safety may be obtained.

A system for the inductive transfer of power is provided, which comprises a primary device and a secondary device and a control unit. The primary device is designed to inductively transfer power via a primary oscillating circuit to a secondary oscillating circuit of the secondary device during the transfer of power. The control unit is designed to record secondary power data of the secondary device and to determine primary target power data using a power characteristic and the recorded secondary power data. The power characteristic comprises reference primary power data as a function of reference secondary power data. The control unit is furthermore designed to record primary power data of the primary device and to detect a foreign object using a comparison of the primary target power data with the primary power data.

Therefore, it can be determined whether the primary device transfers electrical power to a metallic foreign object. A foreign object, optionally an at least partially metallic article, counts as detected, for example, if its presence within a transfer region of the system is discovered. The transfer region is optionally a space in the surroundings of the primary device, within which a significant inductive transfer of power to a metallic foreign object takes place, optionally such that it can result in significant heating of the foreign object. Relevant foreign objects comprise, optionally, a material that is suitable for the inductive transfer of electrical power due to its magnetic properties. Such materials can heat up within the transfer region, for example.

The disclosure may make use of the fact, inter alia, that the presence of a foreign object—optionally a metallic foreign object—in the region of the inductive transfer of power, leads to some of the primary power expended by the primary device draining off, for example by heating the foreign object. To obtain a predefined secondary power, a higher primary power consequently must be adjusted. In the system, the aim now is for the resulting deviation from a “target” value of the primary power to be used to detect the presence of a foreign object.

When there is a foreign object present in the region of the transfer of power, a higher primary power must therefore be expended to provide the same predefined secondary power of the secondary device. A power characteristic is now used, which indicates a correlation between the secondary power data obtained in the secondary device and the primary target power data to be adjusted for this purpose on the part of the primary device. The power characteristic is established optionally in a reference situation in which it can be ensured that no relevant foreign object is present.

In the comparison of the actually adjusted primary power data with the primary target power data according to the power characteristic, a deviation can be determined, for example, which is then compared with a threshold value. If the deviation exceeds the threshold value, optionally for a predefined duration, it is then assumed that a foreign object is present. The control unit can now be designed, if a foreign object is detected, to generate a control signal, for example to stop the inductive transfer of power by the primary device or to reduce the primary power to a predefined value. Alternatively or additionally, a warning signal can be output.

A threshold value used for the evaluation of the comparison between the primary power data and the primary target power data can be permanently predefined, for example. It can be determined as a predefined percentage proportion of the primary target power data, for instance as a proportion, given as a percentage, of a primary target current intensity, such that the greater a parameter value of the primary target power data, the greater the threshold value for a permissible deviation.

The foreign object can be identified dynamically, that is to say at various distances between primary device and secondary device and with different transferred powers.

Since in the system, a foreign object is detected more precisely than in the known systems, even while a rather low power is to be transferred to the secondary device, heating of metallic articles, optionally, can be avoided in the entire power range and distance range of the inductive coupler system. The hazard potential associated therewith may be minimized considerably.

The primary power data or secondary power data, within the meaning of the disclosure, can relate to an electrical power in the primary device or secondary device. Correspondingly relevant parameters are, optionally, a current intensity and/or a voltage. The magnitude of the power arises from the product of current intensity and voltage.

For example, the secondary power data can comprise a secondary voltage and/or a secondary current intensity; the product of these parameters produces, optionally, the electrical power transferred inductively to the secondary device. Optionally, the parameters output by an intermediate circuit of the secondary device are taken into account.

The primary power data can also comprise a primary voltage and/or a primary current intensity; the product of these parameters produces, optionally, the power that is expended in the primary device during the inductive transfer of power to the secondary device. Optionally, the parameters output by an intermediate circuit of the primary device are taken into account.

In one implementation of the system, the primary power data can relate to a primary current in a primary intermediate circuit of the primary device. Optionally, the primary intermediate circuit of the primary device can be operated with a predefined constant primary voltage.

Furthermore, the secondary power data can relate to a secondary voltage induced in a secondary intermediate circuit of the secondary device and to a secondary current supplied from the secondary intermediate circuit of the secondary device.

In one implementation, the primary device can be operated with a predefined primary voltage. In such a case, it may be sufficient that the primary power data recorded by the control unit comprise a primary current intensity. Optionally, the primary voltage then does not need to be recorded separately; it can furthermore be assumed to be constant for the evaluation.

During the inductive transfer of power—with the primary voltage kept substantially constant—the primary current intensity can be regulated in such a way that predefined secondary power data are obtained.

In further examples, the primary-side voltage can also be regulated. Optionally, the primary-side power, that is to say the product of input current and input voltage, can be a control variable.

The primary target power data determined by the control unit can relate to a primary target current intensity.

In one implementation of the system, the control unit can be incorporated in the primary device. In further implementations, said control unit can be incorporated in the secondary device or be formed as an external control unit, for instance as a control module of a higher-level control system.

The primary power data and secondary power data can be recorded in a manner known per se using suitable sensors. The measured values can be transferred to the control unit in various ways.

In a further implementation, the control unit can be designed to record the secondary power data via an IO-link connection. Alternatively or additionally, other types of data connection can be provided. The data connection can be between a primary interface of the primary device and a secondary interface of the secondary device.

The IO-link connection or other data connection can be between the primary device and the secondary device, optionally when the control unit is incorporated in the primary device. In this case, the primary power data can be recorded directly by a sensor and passed to the control unit and the secondary power data can be transferred to the control unit via an IO-link connection or via another data connection.

In a further implementation of the system, a data connection, optionally for transferring the secondary power data to the primary device, can be realized by modulating a signal for data transfer onto the electromagnetic field for the inductive transfer of power, wherein this makes it possible optionally to transfer data from the primary device to the secondary device.

The control unit of the system can determine primary target power data using a power characteristic and using the recorded secondary power data. For example, a primary target current intensity can be determined. It is assumed optionally that the primary device is operated with a permanently predefined primary voltage, while the primary current intensity is regulated to obtain a requested secondary power.

The power characteristic can be saved in a storage device that is connected to the control unit or incorporated therein, for instance for a certain type or model of the system.

In one implementation, the power characteristic can be determinable using at least one power reference measurement or using a plurality of power reference measurements. In the power reference measurement, actual primary power data of the primary device are measured based on a plurality of reference secondary power data of the secondary device.

For example, the reference secondary power data can comprise a plurality of parameter values of the secondary power data, which are distributed optionally equidistantly within an interval that extends over a working range of relevant secondary power data.

For the power reference measurement, the system or an identical system can be measured without a foreign body. For example, the primary current intensity can be regulated at a predefined primary voltage of the primary device in order to obtain determined values of the secondary power output in the intermediate circuit of the secondary device. A value of a primary frequency of the primary device can be predefined or the primary frequency can also be regulated. In the example, these determined values of the secondary power can be arranged equidistantly within an interval; the interval in which the power reference measurements are performed can correspond to an operational region of the electrical power that is inductively transferable using the system.

Optionally, the reference primary power data are determined using the measured actual primary power data in such a power reference measurement. The data measured in the power reference measurement can be filtered, smoothed and/or processed using averaging, for example.

In a development, in the power reference measurement, the actual primary power data can be measured based on a plurality of reference distances within a predefined working region between the primary device and the secondary device.

The reference primary power data can be determined based on the reference secondary power data using the maximum actual primary power data measured within the predefined working region.

For example, a working region can be predefined that specifies a minimum distance and/or a maximum distance between the primary device and the secondary device. In the power reference measurement, the actual primary power data can be measured based on the reference secondary power data at various distances. In this way, the dependency of the inductive transfer of power on the distance between transmitter and receiver is taken into account and the power characteristic of the system can be determined more accurately; as a consequence, the primary target power data can also be determined more accurately using the secondary power data.

In one implementation, the power characteristic can be established using a regression analysis, optionally a linear or polynomial curve fitting, as a function of the measured actual primary power data on the basis of the reference secondary power data. The power characteristic determined using regression can relate to the correlation between the reference primary power data and the reference secondary power data.

Optionally, a compensation calculation is performed using the least square (LS) method.

For example, in the fit, the parameters of an n-th degree polynomial can be established, such as first degree for a linear curve.

In a method for determining the power characteristic, a power reference measurement can be performed, wherein actual primary power data of the primary device can be measured based on a plurality of reference secondary power data of the secondary device. Reference primary power data are then determined using the measured actual primary power data. The power characteristic then indicates a correlation between the reference primary power data and the reference secondary power data.

For example, a primary current of the primary device can be measured, which can be adjusted at a permanently predefined primary voltage such that a determined reference secondary power is obtained in the secondary device. This measurement can be affected for a plurality of values of the reference secondary power, such that a curve arises that depicts a correlation between the adjusted primary current and the secondary power. The product of the predefined primary voltage and the primary current can correspond to a primary power.

Optionally, the measurements can be affected for various distances between the primary device and the secondary device, such that furthermore a dependency of the primary current or of the primary power on the distance is determined. The reference distances can be selected within a predefined working region between the primary device and the secondary device.

In a further implementation of this method, the reference primary power data can be determined based on the reference secondary power data using the maximum actual primary power data measured within the predefined working region. That is to say, it is determined which maximum primary current is adjusted if a determined secondary power is to be obtained-provided that, in the reference measurement, primary device and secondary device are at a distance from one another within the working region and there is no metallic object in the vicinity of the transfer.

Using the curve obtained in this way, a compensation calculation can then be carried out to obtain the parameters of a curve, for example a linear or other approximation curve, which can then be used as a power characteristic.

In a further implementation of the system, the control unit can be designed to determine an actual distance between the primary device and the secondary device and to determine the primary target power data furthermore using the actual distance. As a result, advantageously the dependency of the power characteristic on the actual distance between primary device and secondary device can be taken into account and the primary target power data can be determined more accurately. In an additional implementation, a position of the devices in relation to one another can furthermore be taken into account, such as an angle of the devices relative to one another.

In one implementation, the control unit can be designed furthermore to record a frequency parameter of the primary device for determining the actual distance and to determine the actual distance using a distance characteristic field, the recorded frequency parameter, and the recorded secondary power data.

Optionally, the distance characteristic field can reproduce a correlation between the distance between the primary device and the secondary device, the frequency parameter, optionally the primary frequency of the primary device, adjusted for the transfer of power, and the transferred secondary power, optionally the secondary voltage of the secondary device.

The distance characteristic field is, optionally, independent of the primary current intensity adjusted in the primary device. In this way, the distance between primary device and secondary device can be determined, to improve the detection of a foreign object without the primary current intensity, which is dependent on the potential presence of a foreign object, having a disruptive effect.

In one implementation, the distance characteristic field can be determinable using a distance reference measurement, wherein in the distance reference measurement, actual secondary power data of the secondary device are measured based on a primary frequency of the primary device for a plurality of reference distances within a predefined working region between the primary device and the secondary device. It can furthermore be provided that the parameters of a function are determined based on a compensation calculation, which then corresponds to a characteristic of the distance characteristic field.

The disclosure can relate to a primary device for a system for the inductive transfer of power from the primary device to a secondary device. The primary device can comprise a control unit and a primary device interface, wherein the control unit is designed to record, via the primary device interface, secondary power data of a secondary device coupled to the primary device for the inductive transfer of power and to determine primary target power data using the recorded secondary power data and a power characteristic. The power characteristic can comprise reference primary power data based on reference secondary power data. The control unit can be designed to record primary power data of the primary device and to detect a foreign object using a comparison of the primary target power data with the primary power data.

The primary device can be a primary device for the above-described system and therefore the corresponding developments specified in the present description are conceivable.

In the method for operating a system for the inductive transfer of power from a primary device to a secondary device, primary power data of the primary device and secondary power data of the secondary device can be recorded during the inductive transfer of power. Primary target power data can be determined using a characteristic and using the recorded secondary power data. A foreign object can be detected using a comparison of the primary target power data with the primary power data.

The method can be configured to operate the above-described system and the primary device. The implementations and developments explained in the present description can therefore also be applied to the method.

When a foreign object is detected, a switching signal can be generated, for instance to stop the inductive transfer of power by the primary device.

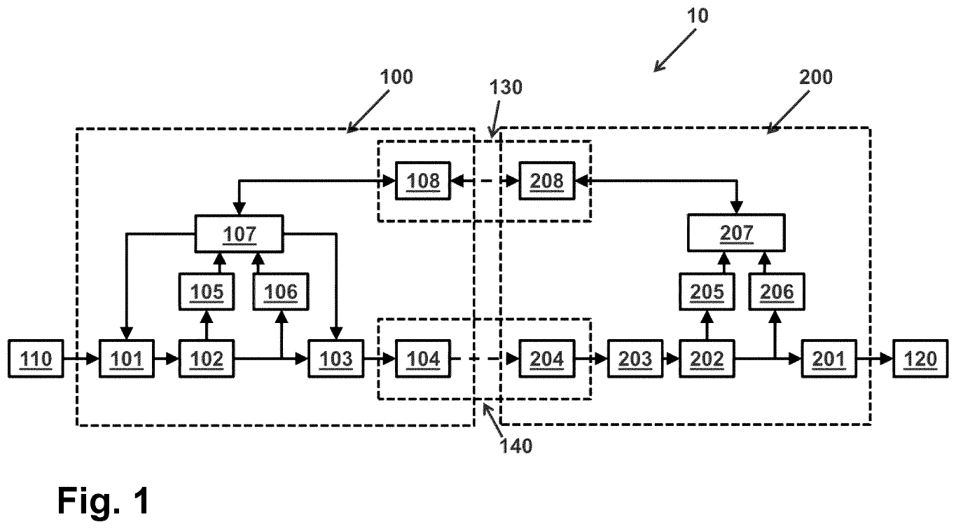

With reference to FIG. 1, an exemplary implementation of a system 10 for the inductive transfer of power and for detecting a metallic object in the electromagnetic field between a primary device 100, here a transmitter, and a secondary device 200, here a receiver, during the contactless transfer of power will be explained.

The system 10 comprises the primary device 100 and the secondary device 200.

In the exemplary implementation, the primary device 100 comprises an individual coil 104, located in a (primary) oscillating circuit, for the inductive transfer of energy between the coupled primary device 100 and secondary device 200, wherein the primary device 100 adopts the role of the transmitter.

Furthermore, it comprises an activation unit 107 for adapting the load-dependent and distance-dependent oscillating circuit frequency and a voltage converter 101 with constant output voltage and an intermediate voltage circuit 102 for adapting the input voltage to the oscillating circuit voltage.

The primary device 100 furthermore comprises an amplifier 103, optionally a “Current-Mode Class-D Amplifier”, for adapting the control signals of the activation unit 107 to the oscillating circuit with the individual coil 104 and a current measuring unit 106 between the intermediate voltage circuit 102 and an amplifier 103.

The primary device 100 furthermore comprises a voltage measuring unit 105 at the intermediate voltage circuit 102 and an evaluation and activation unit 107 for activating the voltage converter 101 and the amplifier 103.

The primary device 100 furthermore comprises an interface for data transfer 108 between a coupled primary device 100 and secondary device 200, wherein an IO-link method optionally can be used to operate a data connection to the secondary device 200.

The secondary device 200 also comprises an individual coil 204, located in a (secondary) oscillating circuit, for the inductive transfer of energy between the coupled primary device 100 and the secondary device 200, wherein the secondary device 200 adopts the role of the receiver.

The secondary device furthermore comprises a rectifier 203 with an intermediate voltage circuit 202 for storing the received energy.

The secondary device 200 additionally comprises a voltage converter 201 for adapting the intermediate circuit voltage to the output voltage and a current measuring unit 206 between the intermediate voltage circuit 202 and the voltage converter 201.

The secondary device 200 furthermore comprises a voltage measuring unit 205 at the intermediate voltage circuit 202 and an interface for data transfer 208 between the secondary device 200 and the primary device 100 data-coupled thereto.

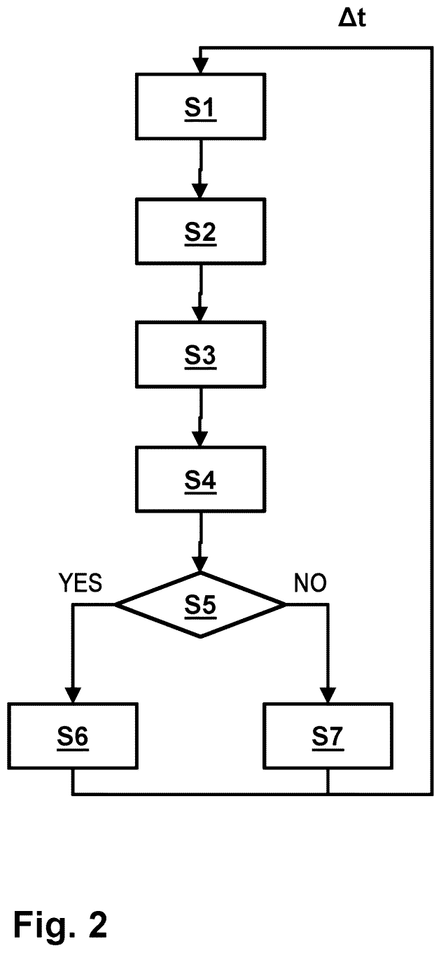

With reference to FIG. 2, furthermore a method for operating the system 10 explained above with reference to FIG. 1 will be explained. The method is used optionally to detect a foreign object in the region of the electromagnetic field during the inductive transfer of power.

During the transfer of power between primary device 100 and secondary device 200, the intermediate circuit voltage (secondary voltage, U_{sec}) induced in the secondary device 200 and the current (secondary current, I_{sec}) provided from the intermediate circuit 202 of the secondary device 200 are recorded cyclically, in the present example at intervals of Δt=10 ms. These values are transferred to the corresponding interface 108 of the primary device 100 via the interface 208.

In the exemplary implementation, a data connection in accordance with IO link is used, but another type of data transfer can also be selected, optionally cabled or cable-free. For example, the data can also be transferred by modulating a carrier signal onto the transferred electrical power, such that the data and the electrical power are transferred via the same channel.

From the values recorded in this way, the present power (P_{sec}=U_{sec}·I_{sec}) of the secondary device 200 is determined in a step S1. Furthermore, the present primary current Iₚᵣᵢ is recorded in this step S1.

In a step S2, the recorded data are averaged or smoothed over a determined time interval. This gives averaged values for the primary current I_{pri_avr} and for the secondary power P_{sec_avr}.

In the present example, a distance d between the primary device 100 and the secondary device 200 is assumed, which is in a working range from 0 mm to 7 mm. Furthermore, a load current I_{sec} of the secondary device 200 in a range from 0 mA to 750 mA is assumed in the example. In other examples, other ranges for the distance d and load current I_{sec} may be provided.

In the event that there is no metallic foreign object located in the electromagnetic field between primary device and secondary device, a ratio-linear in the first approximation-arises between the input current in the resonant circuit of the primary device (primary current, Iₚᵣᵢ) and the secondary output power of the intermediate circuit of the secondary device (secondary power, P_{sec}=U_{sec}·I_{sec}).

This ratio is indicated by a power characteristic which is saved in the evaluation and control unit 107 of the primary device 100 and is evaluated thereby. The power characteristic has, for instance, the following form:

$${I}_{pri \_ target} = m \cdot {P}_{sec \_ avr} + n$$

In a step S3, during the transfer of power, the “target” primary current (target primary current, I_{pri_target}) for the resonant circuit of the primary device 100 is calculated cyclically using the power characteristic on the basis of an averaged, that is to say smoothed during the recording, recorded output power of the intermediate circuit 202 of the secondary device 200 (averaged secondary power, P_{sec_avr}). That is to say, the target primary current I_{pri_target} is established, which should be adjusted in accordance with the power characteristic to provide a determined (averaged) secondary power P_{sec_avr}.

This allows for a work-point-accurate evaluation of the actually measured and averaged input current I_{pri_avr} in the resonant circuit of the primary device 100 and of the present calculated “target” input current I_{pri_target} in the resonant circuit of the primary device 100.

A metallic foreign object in the electromagnetic field between primary device 100 and secondary device 200 during the inductive transfer of power leads to power being drawn, for instance by heating the foreign object. This power is provided by the primary device 100, but not received by the secondary device 200. The primary current I_{pri_avr} must therefore be increased beyond the calculated “target” input current I_{pri_target}, in order to still provide a determined secondary power.

In a step S4, the calculated primary target input current I_{pri_target} is used to determine a maximum permissible input current I_{pri_max}, which exceeds the calculated target input current I_{pri_target}, for example, by a determined percentage x %:

$${I}_{pri \_ max} = {I}_{pri \_ target} + {I}_{pri \_ target} \cdot x \%$$

The actually recorded primary current I_{pri_avr} is compared with the maximum permissible input current I_{pri_max} and when exceeded, that is to say at this threshold value, that is to say at I_{pri_avr}≥I_{pri_max}, there is an impermissible deviation of the actual averaged input current in the resonant circuit of the primary device 100.

It is concluded from this, optionally, that a foreign object is present.

In a step S6, a corresponding output is then generated, such as a warning message and/or a switching signal, which aborts the inductive transfer of power, for example.

If the threshold value is not exceeded, that is to say at I_{pri_avr}<I_{pri_max}, no output is generated in a step S7. Alternatively, an output can be generated in order to indicate that no foreign object was detected.

The method is repeated in the loop according to the predefined interval Δt.

The deviation between the measured and the calculated input current in the resonant circuit of the primary device 100 can be evaluated regardless of which working ranges are predefined for the transferable power and/or the distance between primary device 100 and secondary device 200. The method can be employed for higher secondary powers (such as >18 W) and/or greater distances (such as >7 mm), for example. For this, the power characteristic optionally should be determined over the total working ranges used for distance and/or secondary power.

In this respect, the method is easily adaptable for various working ranges of the secondary power and of the distances, optionally by using power characteristics for corresponding working ranges.

The method can identify metallic deposits, for example on the front cap of one of the primary devices 100 and/or secondary devices 200, early. Therefore, maintenance work and cleaning work on the coupler system can be designed in such a way that the wear and the energy requirement are reduced.

By safely and rapidly identifying foreign objects, the hazard posed by heated metallic articles in the electromagnetic field between primary device 100 and secondary device 200 during the inductive transfer of power is additionally reduced.

The method for dynamically identifying foreign objects will be explained again below in other words.

The method is based on the functional correlation between the input current (I_{pri_target}) in the oscillating circuit of the primary device 100 without foreign object and its regulation in order to obtain, at a predefined primary voltage (Uₚᵣᵢ), a determined secondary output voltage (U_{sec_target}) and a secondary output current (I_{sec_target}_{^{∥}}) at the intermediate voltage circuit 202 of the secondary device 200 without foreign object.

Fct. 1 shows the mentioned functional correlation:

$${I}_{pri \_ target} = f ( {U}_{sec \_ target} , {I}_{sec \_ target} ) \qquad Fct . 1$$

I_{pri_target} [A] input current in the oscillating circuit of the primary device without foreign object
U_{sec_target} [V] voltage at the intermediate circuit capacitor of the secondary device without foreign object
I_{sec_target} [A] current from the intermediate circuit capacitor of the secondary device without foreign object
P_{sec_target} [W] output power from the intermediate voltage circuit of the secondary device without foreign object

The function Fct. 1 can be transformed using the following equation Eq. 1:

$${P}_{sec \_ target} = {U}_{sec \_ target} , {I}_{sec \_ target} \qquad Eq . 1$$

P_{sec_target} [W] output power from the intermediate voltage circuit of the secondary device without foreign object (205, 206)

This gives, for the function Fct. 2, the correlation:

$${I}_{pri \_ target} = f ( {P}_{sec \_ target} ) \qquad Fct . 2$$

Since the voltage converter 101 of the primary device 100 generates a constant output voltage (Uₚᵣᵢ) at the intermediate voltage circuit 102, the output voltage (Uₚᵣᵢ) is not taken into account hereinafter for the exemplary implementation.

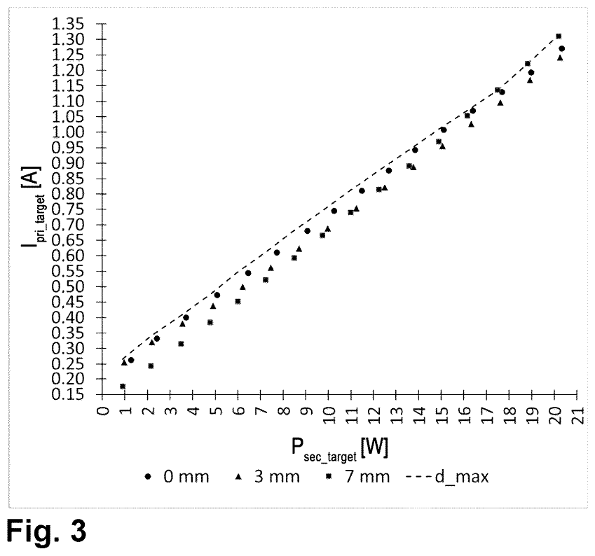

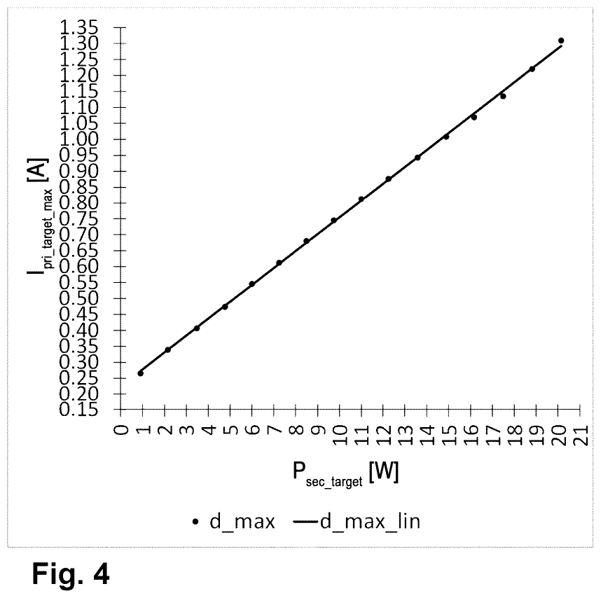

With reference to FIG. 3 and FIG. 4, measurements for establishing a power characteristic will be explained by way of example. In FIG. 3, measurements for distances d of 0 mm, 3 mm and 7 mm between the mutually facing cover caps of the primary device 100 and secondary device 200 are shown for the sake of clarity, but measurements at narrower intervals were undertaken and evaluated.

The measurements of the adjusted actual primary current I_{pri_target} were furthermore affected in a range of the secondary output power P_{sec_target} from approximately 1 W to approximately 20 W. A measurement of the correlation of I_{pri_target}=f(P_{sec_target}) is therefore affected over d of 0 mm to 7 mm.

The exemplary method for dynamically identifying foreign objects is based on the assumption that the functional correlation specified in function Fct. 2 can be approximated well as a linear characteristic.

For this purpose, on the basis of the measured function characteristics shown in FIG. 3, the measured maximum value I_{pri_target_max}=f(P_{sec_target_min}) of all the function characteristics taken into account is used for the dependent variable I_{pri_target} from function Fct. 2 at each point on the curve. The distance dependency of the correlation is therefore circumvented by evaluating the highest measured values I_{pri_target} in each case for each value of the secondary power P_{sec_target} as the relevant points of the power characteristic.

These maximum values I_{pri_target_max} are indicated as a dashed line d_max in FIG. 3.

The resulting function characteristic is subsequently linearized, by determining the parameters of a linear fit function based on or using compensation calculation, optionally using the least square method.

The slope (m) and the displacement constant (n) of the linearized function characteristic are saved as parameters.

In further exemplary implementations, another function can be used for the fit, such as an n-th order polynomial.

In FIG. 4, the maximum values I_{pri_target_max} are indicated as points d_max and the linearized function I_{pri_target_max}=f(P_{sec_target_min}) is indicated as a continuous curve d_max_lin.

For the maximum values I_{pri_target_max} of the function characteristic profiles from Fct. 2 over the distances d of 0 mm to 7 mm, the following applies:

$${I}_{pri \_ target \_ max} = f ( {P}_{sec \_ target \_ min} ) \qquad Fct . 3$$

I_{pri_target_max} [A] maximum input current in the oscillating circuit of the primary device without foreign object
P_{sec_target_min} [W] minimum output power from the intermediate voltage circuit of the secondary device without foreign object

In addition, the following equation Eq. 2 applies:

$${P}_{sec \_ target \_ min} = {U}_{sec \_ target \_ min} \cdot {I}_{sec \_ target \_ min} \qquad Eq . 2$$

U_{sec_target_min} [V] minimum voltage at the intermediate circuit capacitor of the secondary device without foreign object
I_{sec_target_min} [A] minimum current from the intermediate circuit capacitor of the secondary device without foreign object

The “minimum” voltage or current intensity of the intermediate circuit capacitor of the secondary device are understood to be the respective values which are obtained at least at a predefined primary current I_{pri_target}′. That is to say, the minimally achieved secondary power P_{sec_target_min} in the secondary device and the primary current I_{pri_target}′ maximally expended therefor are correlated. As a result, the power characteristic is determined in such a way that sufficient reserves are provided in any case to attain the desired power using the inductive transfer of power.

For the linearization of the function Fct. 3, a fit to an equation as indicated in Eq. 3 is performed:

$${{I}_{pri \_ target}}^{′} = m \cdot {P}_{sec \_ target \_ min} \qquad Eq . 3$$

I_{pri_target}′ [A] linearized maximum input current in the oscillating circuit of the primary device without foreign object (106)
m [V−1] slope of the function Fct. 3 (here: 0.053)
n [A] displacement constant of the function Fct. 3 (here: 0.2245)

FIG. 4 shows, by way of example, the linearized function characteristic of the Fct. 3 for the measured maximum values at the distances d of 0 mm to 7 mm. A maximum and linearized power characteristic profile for I_{sec_target_max}=f(P_{sec_target_min}) over d of 0 mm to 7 mm is shown using compensation calculation.

If during the transfer of power, there is a metallic foreign object located in the electromagnetic field between primary device and secondary device, this generates an impermissible deviation of the input current, calculated on the basis of the Fct. 3, in the oscillating circuit of the primary device (I_{pri_target}′) and is consequently identified as a foreign object.

To calculate the maximum permissible input current in the oscillating circuit of the primary device, the following applies:

$${I}_{pri \_ max} = {{I}_{pri \_ target}}^{′} + {{I}_{pri \_ target}}^{′} \cdot x \% \qquad Eq . 4$$

I_{pri_max} [A] maximum permissible input current in the oscillating circuit of the primary device
I_{pri_target}′ [A] linearized maximum input current in the oscillating circuit of the primary device without foreign object
x % [−] permissible deviation, indicated as a percentage, of the linearized maximum input current in the oscillating circuit of the primary device without foreign object

As becomes clear from the above description, there is a correlation between the primary-side input power Pₚᵣᵢ, to which the input current Iₚᵣᵢ and the input voltage Uₚᵣᵢ held constant in the example, and the secondary-side output power P_{sec}, to which the output current I_{sec} and the output voltage U_{sec} contribute, and the distance d between primary device 100 and secondary device 200. Expressed simply, the greater the distance d, the more input power Pₚᵣᵢ must be expended on the primary side in order to achieve the same secondary-side output power P_{sec}.

In the procedure illustrated in FIG. 4, the power characteristic is constructed in such a way that the distance d is not taken into account for the comparison with a threshold value of the maximum permissible input current of the primary device.

However, there is a dependency between the target primary power data on the transmitter side, the attained secondary power data on the receiver side and the distance between transmitter and receiver.

In a further exemplary implementation, it is therefore provided that the axial distance d between the transmitter and the receiver is determined and taken into account in order to determine the target primary power or the maximum permissible primary current. To do this, the appropriate power characteristic is determined using a power characteristic field which comprises power characteristics for various values of the distance d.

Optionally, the measurements, shown in FIG. 3, of the values of the adjusted actual primary current I_{pri_target} are evaluated on the basis of the secondary output power P_{sec_target} at various distances d. For each distance d or for a determined range of distances, a separate power characteristic is determined using a compensation calculation and fitted to an n-th order polynomial or to another suitable function using compensation calculation.

The power characteristics recorded for various distances d now form a distance characteristic field.

To evaluate this distance characteristic field, the required secondary-side output power and the distance d must now be recorded. The power characteristic appropriate for the distance d is then determined and, using this power characteristic, the target primary power data are determined, in the example therefore the maximum primary-side input current, wherein a permanently predefined primary-side input voltage is assumed here.

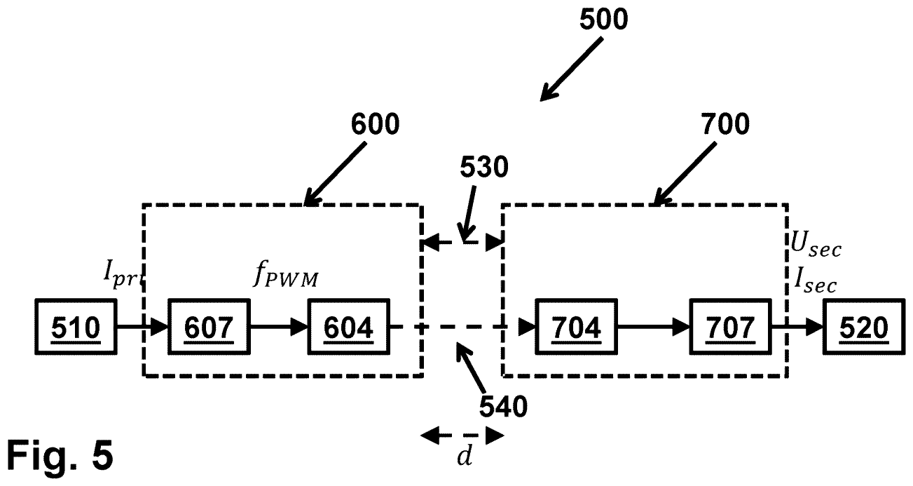

With reference to FIG. 5, the determination of the axial distance between the primary device and the secondary device will be explained below. The system 500 shown here corresponds substantially to the system that was already explained above with reference to FIG. 1. All the elements will therefore not be described in detail again.

The system 500 for the inductive transfer of power comprises a primary device 600 and a secondary device 700. The control unit is not shown separately here, but it is intended to be incorporated in the primary device 600.

During an inductive transfer of power, an activation unit 607 of the primary device 600 is fed by a source 510 with a primary current intensity Iₚᵣᵢ.

The activation unit 607 then provides a pulse-width-modulated signal f_{PWM} in order to activate an oscillating circuit 504. As a result, a primary-side frequency of 105.0 to 129.5 kHz is achieved in the exemplary implementation.

A power transfer 540 is effected from the primary-side oscillating circuit 604 to a secondary-side oscillating circuit 704.

Parallel to this, a data transfer 530 is implemented between the primary device 600 and the secondary device 700, wherein an IO-link connection is provided in the example; in further exemplary implementations, alternatively or additionally, other data connections can be provided.

The alternating voltage induced in the oscillating circuit 704 of the secondary device 700 depends on the distance d between the primary device 600 and the secondary device 700.

By means of this induced alternating voltage, a direct voltage U_{sec} is then generated by a rectifier 707 at an intermediate circuit capacitor of the secondary device 700.

As soon as power is output from the secondary device 700 to a load 520, a measurable secondary current I_{sec} flows from the intermediate circuit capacitor.

The present values for the secondary current I_{sec} and the secondary voltage U_{sec} are measured and transferred to the primary device 600 via the data transfer 530. In the limits of the frequency of the PWM activation signal f_{PWM}, the primary device 600 regulates the intermediate circuit voltage U_{sec} of the secondary device 700 to a desired value, 24 V in the exemplary implementation.

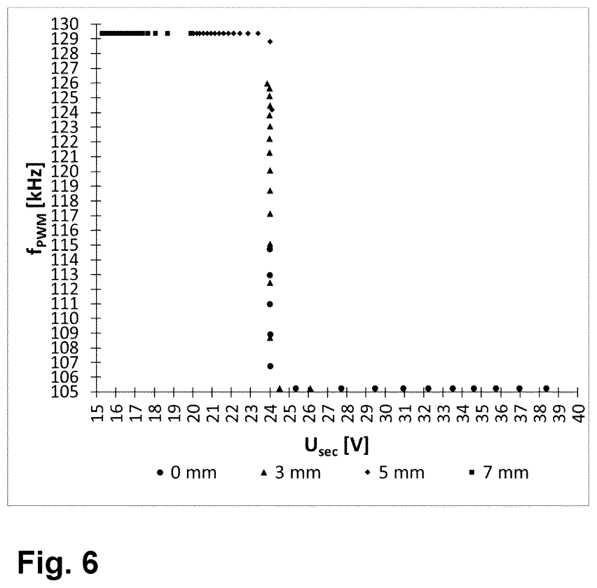

The graph shown in FIG. 6 illustrates, by way of example, a functional correlation between the frequency of the PWM activation signal f_{PWM} of the primary device 600 and the intermediate circuit voltage U_{sec} of the secondary device 700.

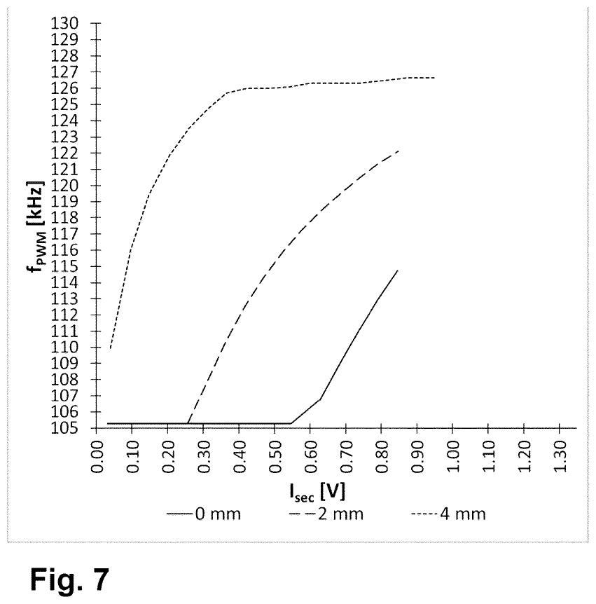

Furthermore, the graph shown in FIG. 7 illustrates, by way of example, a functional correlation between the frequency of the PWM activation signal f_{PWM} of the primary device 600 and the secondary current I_{sec} of the secondary device 700. Curves of measurements at various distances d, here 0 mm, 2 mm and 4 mm, are in this graph.

In order to be able to better evaluate these curves, the secondary power P_{sec}=I_{sec}·U_{sec} is plotted on the x-axis and the value of f_{PWM}·I_{sec}·z is plotted on the y-axis, wherein the factor z=α·xⁿ is determined with a constant α=30 and a parameter x=P_{sec}=I_{sec}·U_{sec} with the exponent n=−1. In this example, this gives the transformation for the values of the y-axis:

$${f}_{PWM} \cdot {I}_{sec} \cdot z = {f}_{PWN} \cdot {I}_{sec} \cdot a \cdot {x}^{n} = {f}_{PWM} \cdot {I}_{sec} \cdot 30 \cdot {( {I}_{sec} \cdot {U}_{sec} )}^{- 1} = 30 \cdot \frac{{f}_{PWM}}{{U}_{sec}}$$

That is to say, the curves shown in FIG. 7 show the correlation of the value f_{PWM}/U_{sec} on the basis of the secondary power P_{sec} for various distances d.

In a further step, the curves measured for the distances d can be fitted using a comparison calculation, wherein the parameters of a third-order polynomial are determined, for example. In this way, in the example the constants (k1,k2,k3,k4) for a polynomial of the form are:

$$Poly 3 ( {f}_{PWM} \cdot {I}_{sec} \cdot z ) = f ( {P}_{sec} ) = k 1 \cdot {{P}_{sec}}^{3} + k 2 \cdot {{P}_{sec}}^{2} + k 3 \cdot {P}_{sec} + k 4$$

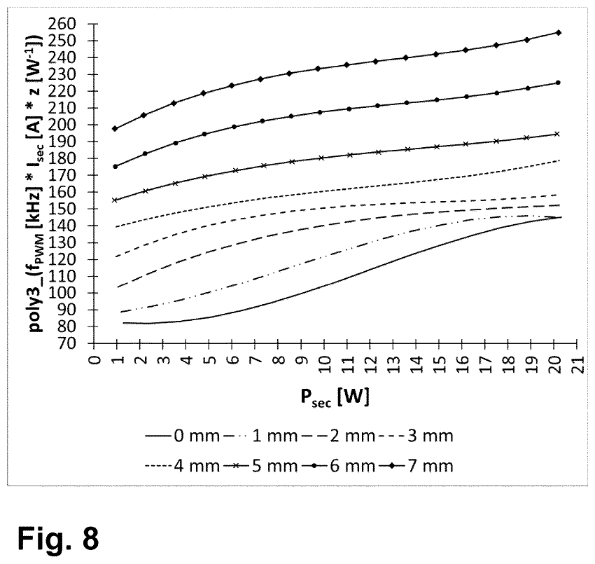

The profiles of such characteristics for the distances d between 0 mm and 7 mm are shown by way of example in FIG. 8. In the exemplary implementation, these characteristics form the distance characteristic field for various distances d.

In order to now determine a distance between the primary device 100, 600 and the secondary device 200, 700, the primary frequency f_{PWM} of the primary device 100, 600 and the secondary power P_{sec} obtained in the intermediate circuit of the secondary device 200, 700 are recorded.

Optionally, the secondary power P_{sec} is transferred from the secondary device 200, 700 to the primary device 100, 600 via the data connection 530, such as an IO-link connection.

It can now be determined which of the characteristics of the distance characteristic field most closely matches the measured value pair. The corresponding distance d is then output and can be used in the detection of foreign bodies, for example.

In further exemplary implementations, the characteristics of the distance characteristic field can be formed in another way. The fundamental idea in this regard consists of the fact that the characteristics represent a correlation between the primary frequency f_{PWM} of the primary device 100, 600 and the secondary power P_{sec}, obtained in the intermediate circuit of the secondary device 200, 700, for various distances d. These parameters are recorded during the inductive transfer of power and a check is made to determine to which characteristic the recorded value pair most closely corresponds. The corresponding distance d can then be specified.

### LIST OF REFERENCE CHARACTERS

10 system
100 primary device; transmitter
101 voltage converter
102 intermediate voltage circuit; primary intermediate circuit
103 amplifier
104 individual coil
105 voltage measuring unit
106 current measuring unit
107 evaluation and activation unit
108 primary interface; interface (data transfer)
110 input
120 output
130 data transfer
140 transfer of power
200 secondary device; receiver
201 voltage converter
202 intermediate voltage circuit; secondary intermediate circuit
203 rectifier
204 individual coil
205 voltage measuring unit
206 current measuring unit
207 evaluation and activation unit
208 secondary interface; interface (data transfer)
500 system
510 source
520 load
530 data connection
540 transfer of power
600 primary device
604 primary oscillating circuit
607 activation unit
700 secondary device
704 secondary oscillating circuit
707 rectifier
d distance
S1, S2, S3, S4, S5, S6, S7 step

What is claimed is:

1. An inductive power transfer system, comprising:
a primary device and a secondary device; and
a control unit;
wherein the primary device is arranged and designed to inductively transfer power via a primary oscillating circuit to a secondary oscillating circuit of the secondary device during the transfer of power;
wherein the control unit is designed to record secondary power data of the secondary device and to determine primary target power data using a power characteristic and the recorded secondary power data;
wherein the power characteristic comprises reference primary power data as a function of reference secondary power data; and
wherein the control unit is designed to record primary power data of the primary device and to detect a foreign object using a comparison of the primary target power data with the primary power data.

2. The inductive power transfer system according to claim 1, wherein the primary power data relate to a primary current in a primary intermediate circuit of the primary device.

3. The inductive power transfer system according to claim 2, wherein the primary intermediate circuit of the primary device is operated with a predefined constant primary voltage;

4. The inductive power transfer system according to claim 1, wherein the secondary power data relate to a secondary voltage induced in a secondary intermediate circuit of the secondary device and to a secondary current supplied from the secondary intermediate circuit of the secondary device.

5. The inductive power transfer system according to claim 1, wherein the control unit is incorporated in the primary device.

6. The inductive power transfer system according to claim 1, wherein the control unit is designed to record the secondary power data via an IO-link connection.

7. The inductive power transfer system according to claim 1, wherein the power characteristic is determinable using a power reference measurement; wherein in the power reference measurement, actual primary power data of the primary device are measured based on a plurality of reference secondary power data of the secondary device.

8. The inductive power transfer system according to claim 7, wherein, in the power reference measurement, the actual primary power data are measured based on a plurality of reference distances within a predefined working region between the primary device and the secondary device.

9. The inductive power transfer system according to claim 8, wherein the reference primary power data are determined based on the reference secondary power data using a maximum actual primary power data measured within the predefined working region.

10. The inductive power transfer system according to claim 7, wherein the power characteristic is established using a regression analysis as a function of the measured actual primary power data base on the reference secondary power data.

11. The inductive power transfer system according to claim 10, wherein the regression analysis includes or is a linear or polynomial curve fitting.

12. The inductive power transfer system according to claim 1, wherein the control unit is designed to determine an actual distance between the primary device and the secondary device and to determine the primary target power data furthermore using the actual distance.

13. The inductive power transfer system according to claim 12, wherein the control unit is designed to record a frequency parameter of the primary device for determining the actual distance; and to determine the actual distance using a distance characteristic field, the recorded frequency parameter, and the recorded secondary power data.

14. The inductive power transfer system according to claim 13, wherein the distance characteristic field is determinable using a distance reference measurement, wherein in the distance reference measurement, actual secondary power data of the secondary device are measured based on a primary frequency of the primary device for a plurality of reference distances within a predefined working region between the primary device and the secondary device.

15. A primary device for an inductive transfer of power from the primary device to a secondary device, comprising:
a control unit and a primary device interface;
wherein the control unit is designed to record, via the primary device interface, secondary power data of a secondary device coupled to the primary device for the inductive transfer of power and to determine primary target power data using the recorded secondary power data and a power characteristic;
wherein the power characteristic includes reference primary power data as a function of reference secondary power data;
wherein the control unit is designed to record primary power data of the primary device and to detect a foreign object using a comparison of the primary target power data with the primary power data.

16. A method for operating a system for an inductive transfer of power from a primary device to a secondary device, comprising:
recording primary power data of the primary device and secondary power data of the secondary device during the inductive transfer of power;
determining primary target power data using a power characteristic and the recorded secondary power data; and
detecting a foreign object using a comparison of the primary target power data with the primary power data.
